(19) United States
(12) Patent Application Publication
(10) Pub. No.: US 2026/0275533 A1
(43) Pub. Date: Sep. 17, 2026

(54) METHOD AND SYSTEM FOR CORROSION-RESISTANT FASTENING OF CARBON FIBER AND METAL STRUCTURES

(71) Applicant: Textron Aviation Inc., Wichita, KS (US)

(72) Inventors: Gene Wesley Paulsen, Wichita, KS (US); Rebekah Nicole Schilberg, Wichita, KS (US)

(21) Appl. No.: 19/077,283

(22) Filed: Mar. 12, 2025

(51) Int. Cl. C23F 13/00

(52) U.S. Cl. CPC C23F 13/005

(57) ABSTRACT

A method for joining carbon fiber with a dissimilar metal while avoiding galvanic corrosion, including arranging carbon fiber sheets and glass sheets into a stack having an overlapping, alternating arrangement at edge regions of the sheets. A region of the stack where the carbon fiber sheets and the glass sheets overlap is a transition band, a region of the stack where the glass sheets extend a first direction away from the transition band is an edge band, and a region of the stack where the carbon fiber sheets extend a second direction (opposite the first direction) away from the transition band is a primary band. The method also includes curing the stack into a single rigid part and attaching the edge band to the metal (e.g., aluminum structure) such that the primary band and the transition band are separated from the metal by the edge band, thus preventing galvanic corrosion.

### BACKGROUND OF THE INVENTION

Galvanic corrosion at interfaces between an aluminum structure and a carbon fiber structure is problematic in the field of aircraft manufacturing. One solution is to add a layer of fiberglass to the carbon fiber layup, between the carbon fiber and the aluminum, thus creating a barrier to prevent contact between the carbon fiber structure and the aluminum, thus preventing galvanic corrosion of the aluminum. However, there are typically holes for fasteners and edges where the carbon fiber butts up against the aluminum structure, creating paths for moisture bridging a path between the carbon fiber structure and the aluminum, which leads to corrosion.

Thus, there is a need for a method of attaching aluminum and carbon fiber that overcomes the deficiencies of the prior art.

### SUMMARY OF THE INVENTION

Embodiments of the current invention address one or more of the above-mentioned problems and provide a distinct advance in the art of joining carbon fiber composite structures with metal structures. In some embodiments, a method for joining a carbon fiber structure and a metal to guard against galvanic corrosion includes a step of arranging sheets of carbon fiber and sheets of glass into a stack having an overlapping, alternating arrangement. Specifically, edge regions of the sheets of carbon fiber and edge regions of the sheets of glass may be overlapped in an alternating arrangement during layup. A region of the stack where the sheets of carbon and the sheets of glass overlap may be a transition band, a region of the stack where the sheets of glass extend a first direction away from the transition band may be an edge band, and a region of the stack where the sheets of carbon fiber extend a second direction away from the transition band may be a primary band. In some embodiments, the first direction is opposite the second direction. The method may also include the steps of curing the stack into a single rigid part and attaching the edge band to the metal (e.g., aluminum). Specifically, attaching the edge band of the single rigid part to the metal may be performed in such a manner that the primary band and the transition band are separated from the metal by the edge band, thus preventing galvanic corrosion.

In another embodiment, a method for joining a carbon fiber structure and aluminum to guard against galvanic corrosion includes a step of arranging sheets of carbon fiber and sheets of fiberglass into a stack such that edge regions of the sheets of carbon fiber and edge regions of the sheets of fiberglass overlap in an alternating arrangement. A region of the stack where the sheets of carbon and the sheets of fiberglass overlap may be a transition band, a region of the stack where the sheets of fiberglass extend a first direction away from the transition band may be an edge band, and a region of the stack where the sheets of carbon fiber extend a second direction away from the transition band may be a primary band. The first direction is opposite the second direction. The method may also include the steps of curing the stack into a single rigid part and mechanically attaching the edge band of the single rigid part to the aluminum such that the primary band and the transition band are separated from the aluminum by the edge band.

In yet another embodiment, an apparatus may include a composite structure and an aluminum structure. The composite structure may include a primary band made of cured composite carbon fiber or composite graphite, a transition band made of alternating layers of cured composite carbon fiber or composite graphite and fiberglass, and an edge band made of glass and absent any of the composite carbon fiber or the composite graphite. The aluminum structure is mechanically attached to the edge band or forms a butt joint with the edge band.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a cross-sectional plan view of a metal structure attached to a structure in accordance with various embodiments described herein;

FIG. 2 is a schematic exploded side view of a plurality of sheets of glass and a plurality of sheets of carbon fiber arranged in an alternating configuration in accordance with various embodiments described herein; and

FIG. 3 is a flow chart depicting a method of joining carbon fiber composite structures with metal structures in accordance with one embodiment of the present disclosure.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Galvanic corrosion is an electrochemical process where two dissimilar metals or materials (e.g., a metal and a carbon fiber material) come into contact with each other in the presence of an electrolyte (like saltwater or moisture), causing the metal to corrode at an accelerated rate due to a potential difference between these two materials, essentially acting as an anode while the other material acts as a cathode. Galvanic corrosion may also be known as bimetallic corrosion or dissimilar metal corrosion.

In arrangements where a graphite, carbon, or carbon fiber structure contacts an aluminum substructure (such as for a wing tip extension in aerospace manufacturing), some processes include a step of placing a layer of glass (e.g., fiberglass) therebetween. This eliminates contact between dissimilar materials and prevents galvanic corrosion. Specifically, the glass layer or fiberglass layer is non-conductive, which prevents electrical contact between the carbon fiber structure and the dissimilar metal such as aluminum, therefore preventing galvanic corrosion. However, when holes are drilled for fasteners, those holes create a path for water to act as a conduit between the carbon fiber structure and the aluminum for the galvanic corrosion to occur. There are also issues when carbon fiber structures form a butt splice with an aluminum substructure. If this joint is not properly sealed, then galvanic corrosion can exist across the joint. However, the application of sealant is highly dependent on operators who apply the sealant and has a tendency to be removed or lost during operation and maintenance.

Thus, to prevent galvanic corrosion introduced via mechanical connection and/or joints between a dissimilar metal and a carbon composite structure (e.g., carbon fiber composite structures, graphite composite structures, and the like), the present invention generally discloses an apparatus 10 comprising a composite structure 12 and a metal structure 14 such as an aluminum structure attached to the composite structure 12. Other metals besides aluminum may be used without departing from the scope of the technology described herein. The composite structure 12 may be made of carbon fiber or graphite composite prepreg material or a wet layup of carbon fiber composite material subsequently cured together along with interlaced glass or fiber glass layers, as later described herein. Any reference to carbon fiber, sheets of carbon fiber, or carbon fiber sheets used herein may be replaced with graphite sheets or graphite composite sheets without departing from the scope of the technology described herein.

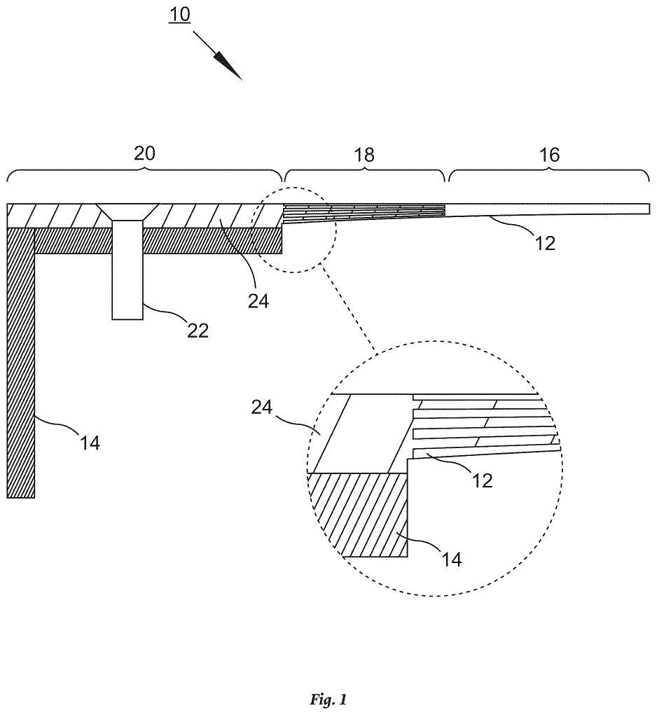

Specifically, the composite structure 12 may be a single integral rigid structure comprising a primary band 16 including cured composite carbon fiber or graphite, a transition band 18 including alternating layers of cured composite material and glass or fiberglass, and an edge band 20 including glass 24 or fiberglass and absent any of the composite carbon fiber or graphite material. The transition band 18 may be located between the primary band 16 and the edge band 20. In some embodiments, as depicted in FIG. 1, the edge band 20 and the transition band 18 may extend from only one side of the primary band 16 (e.g., for attachment of a wing tip extension in aerospace manufacturing). However, in other embodiments, the primary band 16 may have multiple sides from which transition bands and edge bands may extend, depending upon how many sides of the composite structure 12 will be attached to the metal structure 14. In yet another embodiment, the primary band 16 may be fully surrounded along all side edges or edge regions thereof by the transition band 18, with the edge band 20 extending outward from the transition band 18.

The metal structure 14 may be mechanically attached to the edge band 20 or forming a butt joint with the edge band 20 and thus isolating the composite material of the primary band 16 and the transition band 18 from the metal structure 14 (e.g., the aluminum) in order to prevent galvanic corrosion. This galvanic corrosion may most commonly corrode the metal structure 14 but may also degrade the composite structure 12 too, in some embodiments. In some example embodiments, the apparatus 10 may further comprise mechanical fasteners 22 joining the metal structure 14 and the edge band 20. Specifically, the edge band 20 and the metal structure 14 may have aligned holes through which the mechanical fasteners 22 extend. The fasteners 22 can be permanent fasteners or removable screws or bolts, for example, made of stainless steel or other corrosion-resistant materials. In some embodiments, a thickness of the edge band 20 may be greater than a thickness of the primary band 16 (e.g., in order to accommodate sufficient thickness for a countersink of a screw). Furthermore, the transition band 18 may be thicker than the primary band 16 in some embodiments of the technology described herein. In some embodiments, a ramp-like transition may be formed via the transition band 18 and may be thicker proximate to the edge band 20 and thinner proximate to the primary band 16.

A method for making the apparatus 10 is also described herein. Specifically, the method may include attaching carbon composite material and a dissimilar metal by way of interlacing edge regions of multiple layers of fiberglass within an edge region of a graphite or carbon fiber layup to be cured together into a single rigid part having the edge band of glass, the transition band of interlaced layers of glass and composite material, and the primary band of graphite or carbon fiber composite material as described above. Following curing, the method then includes a step of attaching the dissimilar metal (e.g., the aluminum structure) directly to the edge band made of glass or fiberglass, such that the graphite or carbon fiber composite material in the transition band and the primary band does not contact the dissimilar metal.

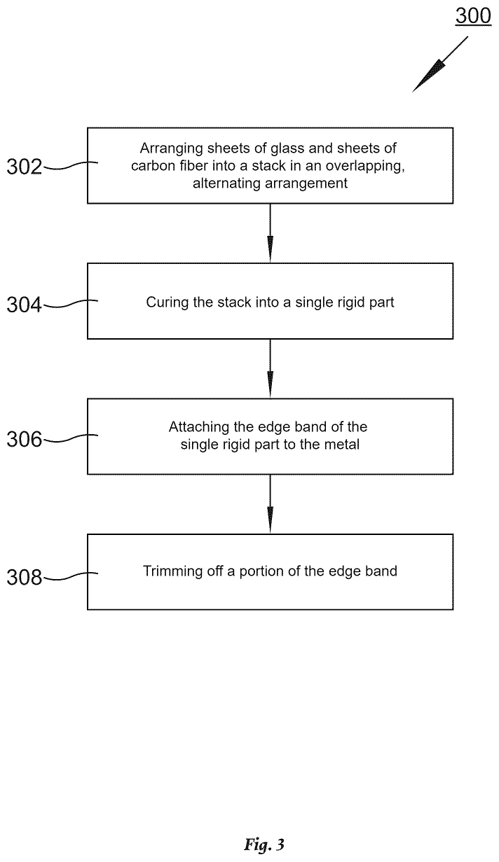

The flow chart of FIG. 3 depicts an exemplary method 300 for joining a carbon fiber composite structure and a metal in a manner that guards against galvanic corrosion. In some embodiments, various steps may be omitted, or steps may occur out of the order depicted in FIG. 3 without departing from the scope of the technology as described herein. For example, two blocks shown in succession in FIG. 3 may in fact be executed substantially concurrently, or blocks may sometimes be executed in the reverse order depending upon the functionality involved.

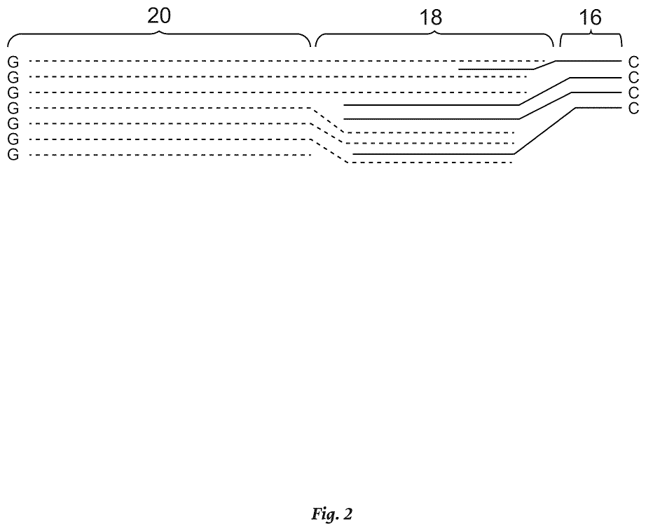

In one or more embodiments, the method 300 may include arranging sheets of glass (labeled G in FIG. 2) and the sheets of carbon fiber (labeled C in FIG. 2) into a stack, as depicted in block 302. This step may be performed such that edge regions of the sheets of glass and edge regions of the sheets of carbon fiber overlap in an alternating arrangement as depicted in FIGS. 1-2. Specifically, a region of the stack where the sheets of carbon and the sheets of glass overlap is the transition band 18 described above, a region of the stack where the sheets of glass extend a first direction away from the transition band 18 is the edge band 16 described above, and a region of the stack where the sheets of carbon fiber extend a second direction away from the transition band 18 is the primary band 16 as described above. In some embodiments, as depicted in FIGS. 1-2, the first direction is opposite the second direction.

Note that the alternating arrangement may include the edge regions of at least two of the sheets of carbon fiber being overlapped onto the edge regions of at least two of the sheets of glass without departing from the scope of the technology described herein. For example, while the overlapping may be a one-to-one overlap arrangement with one glass sheet followed by one carbon fiber sheet followed by one glass sheet and so on, the overlapping may also double up (or triple up) on at least some of the sheets of glass and/or carbon fiber without departing from the scope of the technology described herein. Furthermore, the ratio of glass sheets to carbon fiber sheets can be 1:1, but is not required to be 1:1. For example, in some embodiments there may be more glass sheets than carbon fiber sheets as depicted in FIG. 1. Additionally, the thickness of the glass sheets and the thickness of the carbon fiber sheets may be different than each other or may be identical without departing from the scope of the technology described herein.

In some embodiments, at least some of the edge regions of the sheets of carbon fiber may be of differing lengths than others of the edge regions of the sheets of carbon fiber. Similarly, in some embodiments, at least some of the edge regions of the sheets of glass may be of differing lengths than others of the edge regions of the sheets of glass. Furthermore, the edge regions of the sheets of carbon fiber may be of differing lengths than any of the edge regions of the sheets of glass without departing from the scope of the technology described herein. In general, different ways of interlacing the carbon fiber sheets and the glass sheets, as well as how much overlap is provided (e.g., the configuration of the transition band 18) may be used without departing from the scope of the technology described herein.

The method 300 may further include curing the stack into a single rigid part, as depicted in block 304. This curing may comprise any traditional curing means for composite carbon fiber layups known in the art, such as bagging the stack and using heat and pressure to cure or co-cure the carbon fiber layup with the glass layers interlaced therewith in the transition band. As noted above, the sheets of glass interlaced with the composite carbon fiber layup may be sheets of fiberglass for example.

The method 300 further comprises attaching the edge band of the single rigid part to the metal, as depicted in block 306. For example, this may comprise mechanically attaching the edge band of the single rigid part to a metal structure such as an aluminum structure. This attaching step may be performed such that the primary band and the transition band are separated from the metal by the edge band. In some embodiments, the mechanical attaching of the edge band of the single rigid part to the metal comprises drilling holes through the edge band and the metal and inserting fasteners through the holes. Additionally or alternatively, the mechanical attaching of the edge band of the single rigid part to the metal may comprise forming a butt joint between the edge band and the metal.

In some embodiments, the method 300 may further comprise trimming off a portion of the edge band, as depicted in block 308. This optional step may be performed before and/or after the step of attaching the edge band of the single rigid part to the metal, for example. For example, in some embodiments the sheets of carbon fiber and the sheets of glass may be initially cut or trimmed to a desired size and shape prior to layup and cure into the single rigid part. Then during the process of attaching the single rigid part to the metal or aluminum structure, additional trimming may be required to properly fit these components together. Such additional trimming may be performed along the edge band, retaining enough of the edge band to allow for attachment of the edge band to the metal structure without the metal structure contacting the transition band nor the primary band. Conversely, in prior art methods, trimming of the composite carbon fiber structure could result in trimming away sealant or other barriers, thus providing another location where galvanic corrosion could occur.

The method described above can be used for numerous application, such as for attachment of a wing tip extension or a winglet in aerospace manufacturing. Furthermore, in some embodiments, wings and fuselages can be aluminum, but a fairing that connects the wing and the fuselage may be made of graphite or carbon fiber (which is easier to form into complex contours). Thus, the methods described herein can be used to connect such fairings with such wings and/or fuselages in some example embodiments. Furthermore, although a single screw is depicted in the drawing figures, note that any number of fasteners can be used for the method steps described herein without departing from the scope of this disclosure.

Advantageously, by completely isolating the incompatible materials, galvanic corrosion is prevented. For example, an edge band that is 100% fiberglass or wholly absent of carbon fiber layers can completely isolate an aluminum substructure from the carbon fiber, eliminating any possibility of corrosion occurring via fasteners, screws, or the fastener or screw holes. The glass or fiberglass edge band can also protect an edge of the carbon fiber structure as part of a butt joint with an aluminum structure. Furthermore, in situations where the carbon layups are trimmed during installation, the trimmed edge may also be in a fiberglass region (e.g., the edge band) that is absent the carbon fiber so as not to create a potential galvanic corrosion location.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for joining a carbon fiber structure and a metal to guard against galvanic corrosion, the method comprising:
arranging sheets of carbon fiber and sheets of glass into a stack such that edge regions of the sheets of carbon fiber and edge regions of the sheets of glass overlap in an alternating arrangement, wherein a region of the stack where the sheets of carbon and the sheets of glass overlap is a transition band, a region of the stack where the sheets of glass extend a first direction away from the transition band is an edge band, and a region of the stack where the sheets of carbon fiber extend a second direction away from the transition band is a primary band, wherein the first direction is opposite the second direction;
curing the stack into a single rigid part; and
attaching the edge band of the single rigid part to the metal such that the primary band and the transition band are separated from the metal by the edge band.

2. The method of claim 1, wherein the attaching of the edge band of the single rigid part to the metal comprises drilling holes through the edge band and the metal and inserting fasteners through the holes.

3. The method of claim 1, wherein the attaching of the edge band of the single rigid part to the metal comprises forming a butt joint between the edge band and the metal.

4. The method of claim 1, wherein the metal is a structure comprised of aluminum.

5. The method of claim 1, wherein the sheets of glass comprise sheets of fiberglass.

6. The method of claim 1, further comprising trimming off a portion of the edge band before or after the step of attaching the edge band of the single rigid part to the metal.

7. The method of claim 1, wherein the alternating arrangement includes the edge regions of at least two of the sheets of carbon fiber being overlapped onto the edge regions of at least two of the sheets of glass.

8. The method of claim 1, wherein at least some of the edge regions of the sheets of carbon fiber are of differing lengths than others of the edge regions of the sheets of carbon fiber.

9. The method of claim 1, wherein at least some of the edge regions of the sheets of glass are of differing lengths than others of the edge regions of the sheets of glass.

10. A method for joining a carbon fiber structure and aluminum to guard against galvanic corrosion, the method comprising:
arranging sheets of carbon fiber and sheets of fiberglass into a stack such that edge regions of the sheets of carbon fiber and edge regions of the sheets of fiberglass overlap in an alternating arrangement, wherein a region of the stack where the sheets of carbon and the sheets of fiberglass overlap is a transition band, a region of the stack where the sheets of fiberglass extend a first direction away from the transition band is an edge band, and a region of the stack where the sheets of carbon fiber extend a second direction away from the transition band is a primary band, wherein the first direction is opposite the second direction;
curing the stack into a single rigid part; and
mechanically attaching the edge band of the single rigid part to the aluminum such that the primary band and the transition band are separated from the aluminum by the edge band.

11. The method of claim 10, wherein the mechanical attaching of the edge band of the single rigid part to the aluminum comprises drilling holes through the edge band and the aluminum and inserting fasteners through the holes.

12. The method of claim 10, wherein the mechanical attaching of the edge band of the single rigid part to the aluminum comprises forming a butt joint between the edge band and the aluminum.

13. The method of claim 10, further comprising trimming off a portion of the edge band before or after the step of mechanically attaching the edge band of the single rigid part to the aluminum.

14. The method of claim 10, wherein the alternating arrangement includes the edge regions of at least two of the sheets of carbon fiber being overlapped onto the edge regions of at least two of the sheets of fiberglass.

15. The method of claim 10, wherein at least some of the edge regions of the sheets of carbon fiber are of differing lengths than others of the edge regions of the sheets of carbon fiber.

16. The method of claim 10, wherein at least some of the edge regions of the sheets of fiberglass are of differing lengths than others of the edge regions of the sheets of fiberglass.

17. An apparatus comprising:
a composite structure comprising:
a primary band comprising cured composite carbon fiber or composite graphite,
a transition band comprising alternating layers of fiberglass and the cured composite carbon fiber or the composite graphite, and
an edge band comprising the fiberglass and absent any of the composite carbon fiber or the composite graphite; and
an aluminum structure mechanically attached to the edge band or forming a butt joint with the edge band.

18. The apparatus of claim 17, further comprising mechanical fasteners joining the aluminum structure and the edge band.

19. The apparatus of claim 18, wherein the edge band and the aluminum structure have aligned holes through which the mechanical fasteners extend.

20. The apparatus of claim 17, wherein a thickness of the edge band is greater than a thickness of the primary band.
